(19) United States
(12) Patent Application Publication
(10) Pub. No.: US 2011/0002230 A1
(43) Pub. Date: Jan. 6, 2011

(54) Quality of Service Parameter Relaxation for Non-Conversational Voice Calls Over a Packet-Switched Network

(75) Inventor: Kelce Wilson, Irving, TX (US)

Correspondence Address: Research in Motion Corp./CR;Attn: J. Robert Brown, 5601 Granite Parkway, Suite 750, Plano, TX, 75024, US

(73) Assignee: Research In Motion Limited, Waterloo (CA)

(21) Appl. No.: 12/509,974

(22) Filed: Jul. 27, 2009

Related U.S. Application Data
(60) Provisional application No. 61/222,695, filed on Jul. 2, 2009.

(51) Int. Cl. H04L 12/26; H04L 12/66

(52) U.S. Cl. 370/252; 370/352

(57) ABSTRACT

A method for communication in a packet-switched network. The method includes, when a determination is made that a call that has been set up with a quality of service appropriate for a live voice call will carry recorded voice-based data, decreasing the quality of service used on the call.

### CROSS-REFERENCE TO RELATED APPLICATIONS

The present application claims priority to U.S. provisional patent application No. 61/222,695, filed Jul. 2, 2009, by Kelce Wilson, entitled “Quality of Service Parameter Relaxation for Non-Conversational Voice Calls Over a Packet-Switched Network” (36056-US-PRV-4214-19300), which is incorporated by reference herein as if reproduced in its entirety.

### BACKGROUND

As used herein, the term “mobile device” might refer to devices such as mobile telephones, personal digital assistants, handheld or laptop computers, and similar devices that have telecommunications capabilities. Such a mobile device might consist of a device and its associated removable memory module, or might consist of the device itself without such a module. A mobile device might alternatively be referred to herein with terms such as “device”, “cellular device”, “phone”, “smart phone”, “terminal”, “user terminal”, “user agent”, “UA”, “user equipment”, “UE”, “node”, and the like.

Voice calls carried over a packet switched network require a guaranteed bit rate (GBR) quality of service (QoS) because packets carrying audio information for a voice call must be delivered to the destination node in a timely manner to enable the audio signal to sound like a natural human voice to a human listener. If the voice call audio data packets are delayed too long, for example by being routed over a channel not having a sufficiently rapid packet transit time, the listener at the distant end will likely be dissatisfied with the audio quality provided by the network. The network provider then risks losing a paying customer.

The guaranteed bit rate (GBR) requirement for voice calls creates a perceived burden on packet switched networks and can potentially reduce network capacity. A GBR QoS requirement typically includes not only a data capacity, but also specifies a maximum packet delay time. Because GBR packets have an urgency, which is not typically shared by non-GBR packets, a GBR requirement can result in disparate transmission priorities on a network that transmits both GBR and non-GBR packets over a shared infrastructure. The disparities can potentially cause traffic preemptions of non-GBR packets by GBR packets. These traffic preemptions can, in some circumstances, cause inefficiencies that reduce network capacity, when compared with a network that carries only non-GBR data traffic. Therefore, network providers may seek to minimize the use of channels that specify a GBR requirement.

A current trend in mobile networks is an increase in network traffic load, partially due to the ability of smart phones, also known as converged mobile devices, to view video imagery and edit electronic files such as word processing documents. Network providers are attempting to cope with the increased traffic load, which is accompanied by pressure from their customers for faster data transfers for non-voice data services. The GBR requirement for voice calls, which is a QoS parameter that must be supported by a network in order for a voice call to be successfully placed through the network, can thus add to the network providers' already onerous burden. Easing QoS demands on a network can potentially improve network efficiencies, resulting in lower network equipment costs, more satisfied network users, or both.

When a voice call is to be placed over a packet-switched network, the network is requested to create a channel with a GBR QoS parameter, including a data rate sufficient for a voice communication session. In some situations, streaming audio or video may induce a request for a GBR channel. In a packet switched network, a channel is effectively a communication session, and the process typically requires the network to ascertain whether the capacity is available to support all of the requested QoS parameters, including data rate. If a non-voice data message is to be sent, for example an e-mail or text message, a channel may often be requested with a non-GBR QoS parameter.

If a network is busy, almost at its maximum capacity, at the time that creation of a new channel is requested, the network may deny the request if the requested channel is to be a GBR channel, whereas the network may have granted the request if the requested channel had been for a non-GBR channel.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram illustrating a mobile device and a telecommunications system, according to an embodiment of the disclosure.

FIG. 2 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

When a voice call is determined to not be a live voice call, for example if a caller will be listening to a pre-existing recording instead of a live person, or will be creating a new recording as a voicemail message instead of speaking to a live person, the GBR QoS parameter that was requested when the voice call was initially set up, may be relaxed. For example, a QoS Class Identifier (QCI) could be set to “Non-conversational Voice” in response to a determination that a voice call will not be a live voice call.

This may be accomplished by amending the QoS parameters in the existing channel, if the network permits real-time changes to open channels, or possibly by dynamically switching to a newly-created non-GBR channel and then closing the initially-used GBR channel.

Voice calls are typically set up with the assumption that the channel will carry a live communication between two or more persons. Thus, the channel will be created with a GBR QoS parameter sufficient to carry audio data with sufficient bandwidth to carry a natural-sounding conversation. If a live person answers the call at the distant end, the channel is then in-place and ready. When a live person answers the call, the call is called a live voice call.

However, a live person may not answer. The assumption of a live voice call will be violated if the call turns out to be a recorded call. Recorded calls can be calls in which the caller listens to a pre-recorded message, as well as calls in which the caller speaks to a recording system.

A single call can go through multiple phases. For example, a person dialing a number, hoping that a live person will answer at the distant end, may be greeted by a pre-recorded announcement that indicates the call has been routed to a voicemail system. At the conclusion of the announcement, the caller will be able to speak into the phone, and the caller's voice will be recorded for later playback. Either of the recorded phases, the playing of a pre-recorded message and the recording of a message, presents an opportunity to relax the GBR QoS parameter.

When a pre-recorded message is played as live-sounding audio, the packets comprising the message can be sent over a non-GBR channel, or a slower GBR channel, and buffered at the end of a live listener. Upon reception of enough of the packets, the message can be played from buffer memory, at the expected speed of a live conversation. A trade-off in this situation is that the live caller hears a natural-sounding message, but after a short delay. Another trade-off is that additional system complexity is needed, in order to be able to take advantage of a non-GBR or lower GBR channel. In some situations, the uplink and downlink may have different GBR QoS parameters. Additionally, the user terminal may need to signal to the network that it is compatible with established methods of compensating for low-capacity channels.

Part of this additional complexity is the need for a buffer, either at the caller's device, or elsewhere in the network, in proximity to the caller's device, as well as additional logic and signaling to handle the delayed playback from a buffer. The signaling from the network will include notification of the channel status change, and possibly an indication of the amount of buffering needed, or an estimate of the need. The network would require logic to both receive notification, from the end distant from the caller, that the status of the call will change from a live voice call to a recorded voice call, and also to signal the caller's device with the necessary information. The distant end will need logic to signal the network that a recording will be played. Part of the signaling to the network, which may then be passed along to the buffering location, may include the size or duration of the message which requires buffering. Buffering can be accomplished entirely on a user terminal, or distributed across the air interface and handled, at least in part, by network infrastructure equipment.

Some optional additional complexity is that, upon learning that packets will be arriving on a non-GBR channel, or one of insufficient GBR for natural-sounding audio, and upon learning the size of the message, the average packet delay can be estimated. This estimated average delay, along with the length of the message, can facilitate a calculation of the desired delayed start time for reconstructing the buffered message as a live-sounding audio stream. The start time should be calculated so that the final packets of the message will be expected to have arrived by the time they will be needed.

In the event that the delayed start time will be excessive, or the incoming packet buffer will lack sufficient capacity, the audio can be processed for kerning. Kerning is widely used in typesetting, for example to enable different lines of text to be fully-justified on both left and right margins, even when having different numbers of characters, by adjusting spacing between characters. In the context of audio, delays between spoken words can be extended, in order to lengthen the playback time of a message. The extensions can be proportional to, or otherwise affected by, the initial delay, so that pauses between sentences will be extended longer than shorter pauses between words. This gives the impression of the recorded audio being spoken more slowly, but can begin clearing the packet buffer sooner, and can reduce the wait time before the audio is played. A volume threshold can be used to determine pauses between words, unless the information is already available from the speech encoding.

When a caller's message is recorded for later playback, the packets comprising the message can be buffered at or in close proximity to the source, prior to entering a non-GBR channel (or a reduced-GBR channel), and then converted to a recorded message at the recording node when they arrive. For this scenario, the packets' time of arrival should not determine the sound data location in the recorded message. That is, if the message lasts 20 seconds, but the packets arrive over a 40 second interval, the sound data of the final packet should not be placed in a recorded message 40 seconds after the first packet's sound data, but should instead be placed at the 20 second point in the message.

The caller's device may need a buffer and additional logic to handle the delayed acceptance of the packets by a non-GBR channel of the network, as well as signaling from the network that a non-GBR channel will be used. The network would require logic to both receive notification that the status of the call will change from a live voice call to a recorded voice call, and to signal the caller's device with the necessary information. The recording node will need logic to detect that a recording will be made of incoming audio data, and then to signal the network. The recording node will also need logic to reassemble the packets into a live-sounding audio message, even if reception of the packets is delayed and extended.

If the caller's device is buffering audio packets for delayed transmission into a non-GBR channel, the caller may require some notifications, in certain events. If the buffer becomes full, the caller may be signaled, perhaps with an audio warning, to cease speaking until some of the packets can be cleared from the buffer. The user terminal may need to monitor the rate of offload from the outgoing packet buffer, to estimate when new audio data can be accepted. For example, the user terminal may be programmed to ensure that sufficient buffer capacity is available to enable 30 seconds, or some other duration, of speaking to store packets, based on the difference between income from the audio encoder and outflow to the network over the low-capacity channel. Additionally, when the caller ends the call, the caller may be informed that the device should not be powered off until the remaining packets are transmitted to the network.

A call processed to compensate for a low capacity channel will have some differences from current GBR voice calls. Whereas packets that are delayed and arrive late for GBR channel voice calls are discarded, late-arriving packets for recorded calls can be inserted into their proper location in an audio stream, if they arrive late, so long as they do arrive during the processing time. This is because the audio data is not for a live voice call and will not be played for a listener (or DMTF decoder) until a later time.

Additionally, there may be some cross-talk delay, in which a packet arriving at a destination is overcome by events (OBE), due to the channel delay. One example of this could be that a pre-recorded voicemail greeting is played at a distant end, inviting the caller to record a voicemail. While this pre-recorded greeting message is being played, there is background noise entering the microphone of the caller's terminal and encoded into audio data packets. This audio data is sent to the distant end and, due to the delays of the non-GBR channel, does not arrive until after the distant end has finished playing the greeting and is ready to accept incoming data for recording the voicemail. The distant end can check time information pertaining to the packet, possibly such as a timestamp, and decide whether the packet should be retained as a response to the greeting because it was sent after the greeting completed playing on the user terminal and was intended to be part of the voicemail, or should be discarded because it had been sent before the greeting had completed. Some systems may require that, because of the 2-way delay, certain event timing, such as the completion of a message playback, is returned to the node that caused an event. With such a system, the call timeline can be reconstructed at one end.

Another scenario exists in which a call transitions from a recorded call state to live conversation. This could happen if a person at a distant end picked up a telephone extension after a caller had navigated an automated menu and selected an option that routed the call to a live person. In a situation such as this, the portion of the call, during which the caller was interacting with the automated menu, could be conducted over a non-GBR or a low-GBR channel, but when a live person picked up the call, the call would need to switch to a GBR channel having sufficient capacity to carry natural-sounding audio.

Some networks may access information indicating whether a new call is likely to be a recorded call, for example by comparing the dialed phone number with a list of phone numbers known to be associated with pre-recorded messages, and set up the initial channel as a non-GBR channel (or a reduced GBR channel).

For a QoS relaxation method in which a different, non-GBR channel is substituted for the initial GBR channel, there is a risk that the network may refuse to create a new non-GBR channel. This could occur if the initial GBR channel used the final amount of available network capacity. This risk could be reduced if the network is informed that the requested new, non-GBR channel (or reduced GBR channel) is a replacement for the existing audio-quality GBR channel. The network then will then be able to ascertain that a reduction in the load is expected imminently, and could factor this information into capacity calculations, when determining whether to grant a new channel.

Any other QoS parameters, which are not required to support the audio perception of a live conversation, are also candidates for relaxation.

Sample Methods (which assume uplink and downlink have identical GBR parameters):

Method 1 (pre-recorded message and recording of live message are both processed to compensate for low channel capacity):
1. User initiates a voice call from a user terminal.
2. The network creates an audio-quality GBR channel appropriate for a live voice call.
3. Upon a timeout, without an answer at the distant end, the distant end switches to voicemail.
4. The distant end notifies the network that the call will be a recorded call.
5. The network notifies the user terminal that the channel will be a non-GBR channel (or a low-GBR channel with QoS parameters not suitable for a live voice call).
6. The user terminal signals to the network that it is compatible with low-capacity channel compensation for both incoming and outgoing audio. (If the user terminal is not compatible, then steps 7-27 cannot be performed using buffering on the user terminal, but a similar method may be performed if buffering is done on the base-station side of the air interface. This, however, only saves resources on the network side of the air interface with the user terminal, and so may have lesser value.)
7. The channel is switched to a non-GBR QoS channel (or a low-GBR channel).
8. The distant end sends an indication of the number of packets or the length of the message.
9. The distant end begins playing a pre-recorded message.
10. The user terminal estimates the actual delay time of the packets.
11. The user terminal determines whether it has sufficient buffer capacity to play the pre-recorded message at the original speed, so that the final packets will arrive just in time to be played.
12. If Yes, then
   a. The user terminal calculates the start time of the message.
   b. The user terminal continues to fill the buffer until the calculated start time.
   c. At the calculated start time the packets are converted into an audio stream for a human listener, as newly-arriving packets are stored in the buffer. The buffer is FIFO, and slowly drains as the message is played, just as the buffer empties.
   d. The final packet of the pre-recorded message is played.
13. If No, then
   a. The user terminal selects a delayed start time and performs audio kerning on the message, so that sounds are played at their proper speed, but pauses between sounds are extended.
   b. The final packet of the pre-recorded message is played, just as the buffer empties.
14. The distant end activates a recording system or a dual-tone multi-frequency (DTMF) decoder.
15. The distant end determines whether any packets received were sent prior to activation of the recording system or DTMF system, but arrived late because of slow channel conditions.
16. If Yes (the packets were sent before the recording or DTMF system activation), then
   a. The packets are discarded.
17. If No, then
   a. The packets are processed for recording or DTMF decoding.
18. For outgoing audio from the user terminal, packets containing audio data for the caller's voice, or DTMF tones, are sent to the network in accordance with the channel QoS parameters. (Steps 18-27 below are simultaneous with steps 8-17 above.)
19. The distant end buffers the packets sent by the user terminal.
20. At a later time, since the packets from the user terminal had been processed, either by decoding DTMF tones, or creating a recorded voicemail message, a live-sounding audio signal is available at the distant end, which does not reflect the effect of packet delays caused by a low-capacity channel. Packets are not dropped because of arriving late, but instead they are added to the recording in the proper location.
21. The packet buffer on the user terminal is monitored for capacity.
22. If the user terminal's outgoing packet buffer becomes full
   a. The caller is prompted, such as by an audible or visual alert, to cease speaking for a time,
   b. The buffer for outgoing packets is monitored, and when it has sufficient capacity for additional data, the caller is signaled to begin speaking again.
23. The user terminal signals to the network that the call is to end, for example if the caller hung up.
24. Remaining packets, destined to the user terminal from the distant end, are discarded by the network, without being transmitted over the air interface.
25. The user terminal ceases to play any audio signals from the distant end, and indicates that the call is in the process of termination.
26. The caller is cautioned to not power off the device until the remaining packets from the user terminal's outgoing packet buffer are transmitted.
27. Upon the depletion of the packets from the user terminal outgoing packet buffer, the network is signaled that the call has terminated.
28. The network releases (terminates) the channel.

Method 2 (recording of a message is processed to counteract low channel capacity):
1. User initiates a voice call from a user terminal.
2. The network creates an audio-quality GBR channel appropriate for a live voice call.
3. Upon a timeout, without an answer at the distant end, the distant end switches to voicemail.
4. The distant end plays a pre-recorded message.
5. The distant end activates a recording function.
6. The distant end notifies the network that the call will be a recorded call.
7. The network notifies the user terminal that the channel will be a non-GBR channel (or a low-GBR channel of insufficient quality for a live voice call).
8. The user terminal signals to the network that it is compatible with low-capacity channel compensation. (If the terminal is not compatible, this method is aborted.)
9. The channel is switched to a non-GBR QoS channel (or a low-GBR channel).
10. Same as Method 1, steps 18-28.

Method 3 (changing to live-voice QoS from a low capacity channel):
1. User initiates a voice call from a user terminal.
2. The network identifies that the distant end is associated with pre-recorded audio data.
3. The network creates a low capacity channel, without a GBR QoS parameter appropriate for a live voice call.
4. Call progresses in accordance with low-capacity compensation methods described above.
5. The distant end notifies the network that the call will become a live voice call.
6. The network notifies the user terminal that the channel will become a GBR channel of sufficient quality for a live voice call.
7. The channel is switched to a GBR QoS channel having a GBR QoS parameter appropriate for a live voice call.
8. The call progresses.
9. The call terminates.

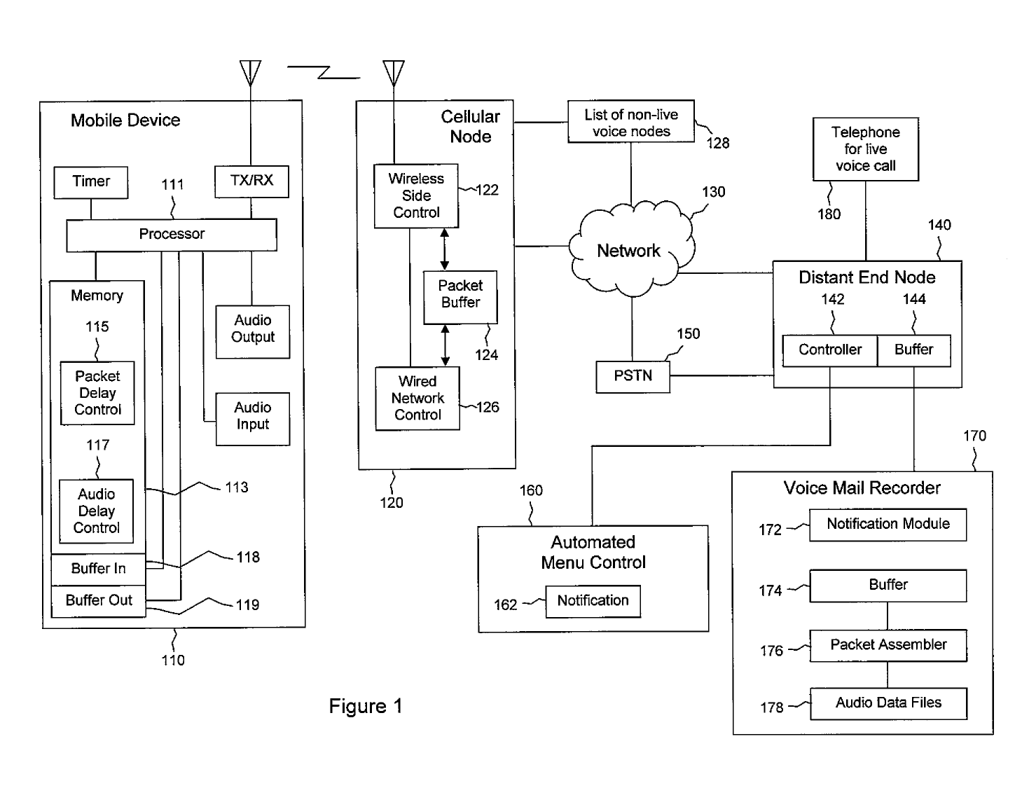

An example of a communication system that may be appropriate for the disclosed embodiments is shown in FIG. 1. In this example, the system includes a mobile device 110 that includes a processor 111 and other components typically included in such a device. In addition, the mobile device 110 includes a memory component 113 that includes a packet delay control component 115 and an audio delay control component 117. Also included are a buffer-in component 118 and a buffer-out component 119. The packet delay control component 115, audio delay control component 117, buffer-in component 118, and buffer-out component 119 can process recorded voice-based data as described above.

The mobile device 110 can communicate wirelessly with a cellular node 120, which might be a base station, an evolved node B, or a similar component. The cellular node 120 might include a wireless side control component 122, a packet buffer 124, and a wired network control component 126. The cellular node 120 might have access to a list 128 of non-live voice nodes as described above. The cellular node 120 can communicate with a network 130, which might be the Internet or any well known telecommunication network.

A distant end node 140 can communicate with the cellular node 120 via the network 130 or via a public switched telephone network (PSTN) 150, which might then communicate with the network 130. The distant end node 140 might include a controller 142 and a buffer 144. The controller 142 might communicate with an automated menu control 160, which might include a notification component 162. The buffer 144 might communicate with a voice mail recorder 170, which might include a notification module 172, a buffer 174, a packet assembler 176, and audio data files 178. The controller 142, buffer 144, automated menu control 160, notification component 162, voice mail recorder 170, notification module 172, buffer 174, packet assembler 176, and audio data files 178 can process recorded voice-based data as described above. A telephone 180 for live voice calls might be used to communicate with the distant end node 140.

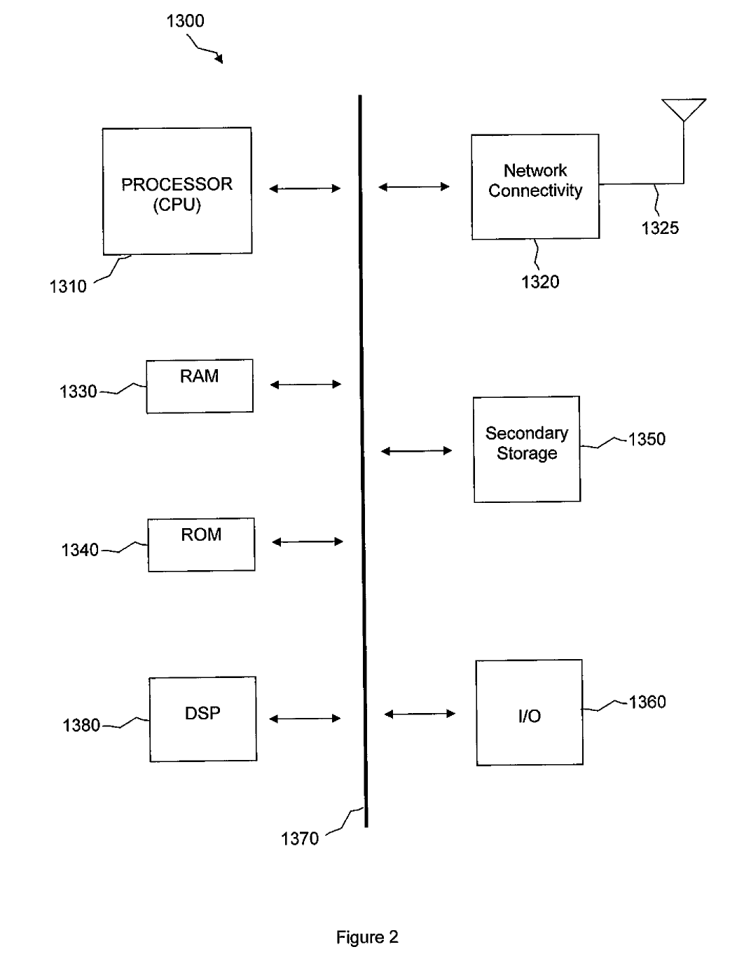

The mobile device 110 and other components described above might include a processing component that is capable of executing instructions related to the actions described above. FIG. 2 illustrates an example of a system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. These components might communicate with one another via a bus 1370. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing, such as a digital signal processor (DSP) 1380. Although the DSP 1380 is shown as a separate component, the DSP 1380 might be incorporated into the processor 1310.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, or optical disk). While only one CPU 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information. The network connectivity devices 1320 might also include one or more transceiver components 1325 capable of transmitting and/or receiving data wirelessly.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs that are loaded into RAM 1330 when such programs are selected for execution.

The I/O devices 1360 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 1325 might be considered to be a component of the I/O devices 1360 instead of or in addition to being a component of the network connectivity devices 1320.

In an embodiment, a method is provided for communication in a packet-switched network. The method comprises, when a determination is made that a call that has been set up with a QoS appropriate for a live voice call will carry recorded voice-based data, decreasing the QoS used on the call.

In an alternative embodiment, a component in a packet-switched network is provided. The component includes a processor configured such that, when a determination is made that a call that has been set up with a QoS appropriate for a live voice call will carry recorded voice-based data, the component decreases the QoS used on the call.

In an alternative embodiment, a mobile device is provided. The mobile device includes a processor configured such that, when a determination is made that a call that has been set up with a quality of service (QoS) appropriate for a live voice call will carry recorded voice-based data, the mobile device decreases the QoS used on the call.

While several embodiments have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for communication in a packet-switched network, comprising:
when a determination is made that a call that has been set up with a quality of service (QoS) appropriate for a live voice call will carry recorded voice-based data, decreasing the QoS used on the call.

2. The method of claim 1, wherein the recorded voice-based data is at least one of:
a pre-recorded message reached by an originator of the call; and
a recording made by the originator of the call into a recording system for later playback.

3. The method of claim 1, wherein the decrease in the QoS used on the call is achieved through at least one of:
modifying a QoS parameter of an existing channel for the call; and
switching the call to a channel with at least one QoS parameter less stringent than at least one QoS parameter appropriate for the voice-based call.

4. The method of claim 3, wherein the decrease in the QoS used on the call is achieved through at least one of:
decreasing a guaranteed bit rate (GBR) of the existing channel;
switching the call to a channel with a GBR lower than a GBR appropriate for the live voice call; and
switching the call to a channel without a GBR.

5. The method of claim 2, wherein, when the recorded voice-based data is the pre-recorded message reached by the originator of the call, packets comprising the pre-recorded message are buffered, and the pre-recorded message is played from buffer memory.

6. The method of claim 5, further comprising receiving an indication that the call includes recorded voice-based data.

7. The method of claim 6, further comprising receiving at least one of:
a size of the pre-recorded message; and
a duration of the pre-recorded message.

8. The method of claim 5, wherein buffering is accomplished in a location that is at least one of:
entirely on a mobile device of the originator; and
distributed across an air interface, wherein the buffering is handled, at least in part, by network infrastructure equipment.

9. The method of claim 2, wherein, when the recorded voice-based data is the recording made by the originator of the call, packets comprising the recording are buffered and then converted to a recorded message at a recording node after arrival at the recording node.

10. The method of claim 9, further comprising transmitting an indication that the call includes recorded voice-based data.

11. The method of claim 1, wherein late-arriving packets of recorded voice-based data are inserted into a proper location in an audio stream.

12. The method of claim 1, wherein, when the call transitions from a recorded call state to live conversation, the call switches to a channel having QoS appropriate for live voice calls.

13. The method of claim 2, wherein, when the recorded voice-based data is the pre-recorded message reached by the originator of the call, a determination is made that the call is likely to include recorded voice-base data by comparing the dialed phone number with a list of phone numbers known to be associated with pre-recorded messages.

14. The method of claim 1, wherein a mobile device promotes decreasing the QoS used on the call.

15. The method of claim 1, wherein a component in the packet-switched network promotes decreasing the QoS used on the call.

16. A component in a packet-switched network, comprising:
a processor configured such that, when a determination is made that a call that has been set up with a quality of service (QoS) appropriate for a live voice call will carry recorded voice-based data, the component decreases the QoS used on the call.

17. The component of claim 16, wherein the recorded voice-based data is at least one of:
a pre-recorded message reached by an originator of the call; and
a recording made by the originator of the call into a recording system for later playback.

18. The component of claim 16, wherein the decrease in the QoS used on the call is achieved through at least one of:
modifying a QoS parameter of an existing channel for the call; and
switching the call to a channel with at least one QoS parameter less stringent than at least one QoS parameter appropriate for the voice-based call.

19. The component of claim 18, wherein the decrease in the QoS used on the call is achieved through at least one of:
decreasing a guaranteed bit rate (GBR) of the existing channel;
switching the call to a channel with a GBR lower than a GBR appropriate for the live voice call; and
switching the call to a channel without a GBR.

20. A mobile device, comprising:
a processor configured such that, when a determination is made that a call that has been set up with a quality of service (QoS) appropriate for a live voice call will carry recorded voice-based data, the mobile device decreases the QoS used on the call.

21. The mobile device of claim 20, wherein the recorded voice-based data is at least one of:
a pre-recorded message reached by an originator of the call; and
a recording made by the originator of the call into a recording system for later playback.

22. The mobile device of claim 20, wherein the decrease in the QoS used on the call is achieved through at least one of:
modifying a QoS parameter of an existing channel for the call; and
switching the call to a channel with at least one QoS parameter less stringent than at least one QoS parameter appropriate for the live voice call.

23. The mobile device of claim 22, wherein the decrease in the QoS used on the call is achieved through at least one of:
decreasing a guaranteed bit rate (GBR) of the existing channel;
switching the call to a channel with a GBR lower than a GBR appropriate for the live voice call; and
switching the call to a channel without a GBR.
